(19) United States
(12) Patent Application Publication
(10) Pub. No.: US 2019/0311650 A1
(43) Pub. Date: Oct. 10, 2019

(54) TRAVEL CALORIE RECOMMENDATION

(71) Applicant: International Business Machines Corporation, Armonk, NY (US)

(72) Inventors: Aiden J. Gallagher, Winchester (GB); Andrew M. Garratt, Andover (GB); David M. Hay, Andover (GB)

(21) Appl. No.: 15/944,949

(22) Filed: Apr. 4, 2018

(51) Int. Cl. G09B 19/00; G06Q 30/06; G09B 5/02; G09B 5/04

(52) U.S. Cl. CPC G09B 19/0092; G09B 5/04; G09B 5/02; G06Q 30/0631

(57) ABSTRACT

A system and method may generate a set of meal recommendations. A calorie remainder for a predetermined period of time may be identified based on health data. Restaurant recommendations may be identified using map data, and meal recommendations and their correlated caloric content may be identified based on restaurant data. A caloric expenditure for travel to each of the restaurants may be determined by the system. Finally a set of meal recommendations is generated, using the meals, the caloric remainder, and the caloric expenditure for travel.

### BACKGROUND

The present disclosure relates to data processing, and more specifically, to caloric intake and expenditure tracking.

Software applications may be used on smart devices like smart phones and personal fitness devices to track a user's fitness during a period of time, for example, a number of steps taken in a day. These smart devices used in fitness tracking may keep logs of a user's daily activities and provide detailed performance reports. The user may set goals within the application in order to achieve certain performance, weight loss, or other health goals.

### SUMMARY

Embodiments of the present disclosure may be directed toward a method for generating a set of meal recommendations. The method may begin when a calorie remainder for a predetermined period of time is identified based on a set of health data. A set of restaurant recommendations may be identified based on a set of map data and a set of calories correlated to a set of meals at each of the restaurants may also be identified using a set of restaurant data. A caloric expenditure may be determined for travel to each restaurant, using the map and health data. And a set of meal recommendations may be generated based on the caloric expenditure for travel, the set of meals and the correlated set of calories, and the caloric remainder for the predetermined period of time.

Embodiments of the present disclosure may be directed toward a system comprising a caloric expenditure engine and a meal generative engine. The caloric expenditure engine may be configured to identify a calorie remainder for a predetermined period of time. The engine may also identify a set of restaurant recommendations based on a set of map data. The meal generative engine may identify a set of calories correlated to a set of meals at each of the restaurants, using a set of restaurant data. The engine may also determine a caloric expenditure for travel to each restaurant, using the map and health data. Finally, the engine may generate a set of meal recommendations based on the caloric expenditure for travel, the set of meals and the correlated set of calories, and the caloric remainder for the predetermined period of time.

Embodiments of the present disclosure may be directed toward a computer program product comprising a computer readable storage medium having program instructions embodied therewith, wherein the computer readable storage medium is not a transitory signal per se, the program instructions executable by a processor to cause the processor to perform a method. The method may begin when a calorie remainder for a predetermined period of time is identified based on a set of health data. A set of restaurant recommendations may be identified based on a set of map data and a set of calories correlated to a set of meals at each of the restaurants may also be identified using a set of restaurant data. A caloric expenditure may be determined for travel to each restaurant, using the map and health data. And a set of meal recommendations may be generated based on the caloric expenditure for travel, the set of meals and the correlated set of calories, and the caloric remainder for the predetermined period of time.

The above summary is not intended to describe each illustrated embodiment or every implementation of the present disclosure.

### BRIEF DESCRIPTION OF THE DRAWINGS

The drawings included in the present application are incorporated into, and form part of, the specification. They illustrate embodiments of the present disclosure and, along with the description, serve to explain the principles of the disclosure. The drawings are only illustrative of certain embodiments and do not limit the disclosure.

FIG. 1 depicts a system diagram for recommending a meal to a user, according to embodiments.

FIG. 2 depicts a flow chart of a method for generating a set of meal recommendations, according to embodiments.

FIG. 3 depicts a flow diagram of a method for recommending and displaying a set of meal recommendations within a particular calorie restriction, according to embodiments.

FIG. 4 depicts a high-level block diagram illustrating an exemplary computer system that can be used in implementing one or more of the methods, tools, components, and any related functions, according to embodiments.

FIG. 5, depicts an illustrative cloud computing environment, according to embodiments.

FIG. 6, depicts a set of functional abstraction layers provided by a cloud computing environment, according to embodiments.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention.

### DETAILED DESCRIPTION

Aspects of the present disclosure relate to data processing, more particular aspects relate to caloric intake and expenditure tracking. While the present disclosure is not necessarily limited to such applications, various aspects of the disclosure may be appreciated through a discussion of various examples using this context.

When a person is actively “calorie counting” in order to achieve a weight-related goal, such as weight loss, gain, or maintenance, it may be helpful for the person to have a plethora of helpful information available to them, so that they may make an informed decision. This information is especially helpful when the individual is planning meals to be eaten out, for example, when determining a working lunch destination or an evening meal in a neighborhood location.

Various embodiments are directed toward a computer system that can actively access existing data to determine a user's remaining calorie allowances for the day, using data including existing meal recommendations, user data regarding caloric expenditure for various activities over various distances, and map data regarding locations of restaurants. As discussed in detail herein, the system may use this and other data to provide curated recommendations to a user that may satisfy caloric, time, and preference considerations. Additionally, modifications to the system may be made based upon changing needs or desires of the user or the user's health care recommendations.

According to embodiments, the computer system can be configured to identify existing data from fitness or health devices or applications to determine a user's remaining caloric allowance for a specified period of time. For example, the computer system can access data from a fitness application on the user's smart phone that indicates a user has 800 calories left to consume for the day to meet his or her caloric goal.

The system can also identify meal recommendation data, for example, from an existing meal recommender application. For example, the system could identify data indicating caloric content of a particular entrée at a particular restaurant. The system may also identify user location data, for example, from a map application on the user's smart phone. The system can then calculate distances to various restaurants based on the user's location. Additionally, the system may identify user-specific biometric or other data such as height and weight, for example, from a fitness application. In embodiments, this data may be used to determine caloric expenditure for the particular user for a particular activity over a certain distance. For example, height and weight data from a fitness application may be identified and used to determine the caloric expenditure (i.e., number of calories ‘burned’) by walking a mile, jogging a few blocks, or cycling thirty miles.

Some embodiments of the present invention may include one, or more, of the following operations, advantages, features and/or characteristics: (i) a method that that uses existing data from fitness devices or applications to determine a user's remaining calorie allowance for the day; (ii) uses existing meal recommendation applications (for example, currently conventional meal recommendation applications); (iii) using the user's current location, calculating the distance to a restaurant; (iv) uses the fitness application user settings to get user metrics such as height and weight as input to existing calorie calculation tools which results in a “calories burnt to destination” number; (v) feeds each restaurant's individual “calories burnt to destination” number into a meal recommendation decision engine to return meal recommendations based on the new calorie allowance when travel to a restaurant is accounted for; and/or (vi) users choose to take a “single” trip such as a walk to restaurants further away or at the end of a walk, or a “return” trip for closer to home or commutable restaurants.

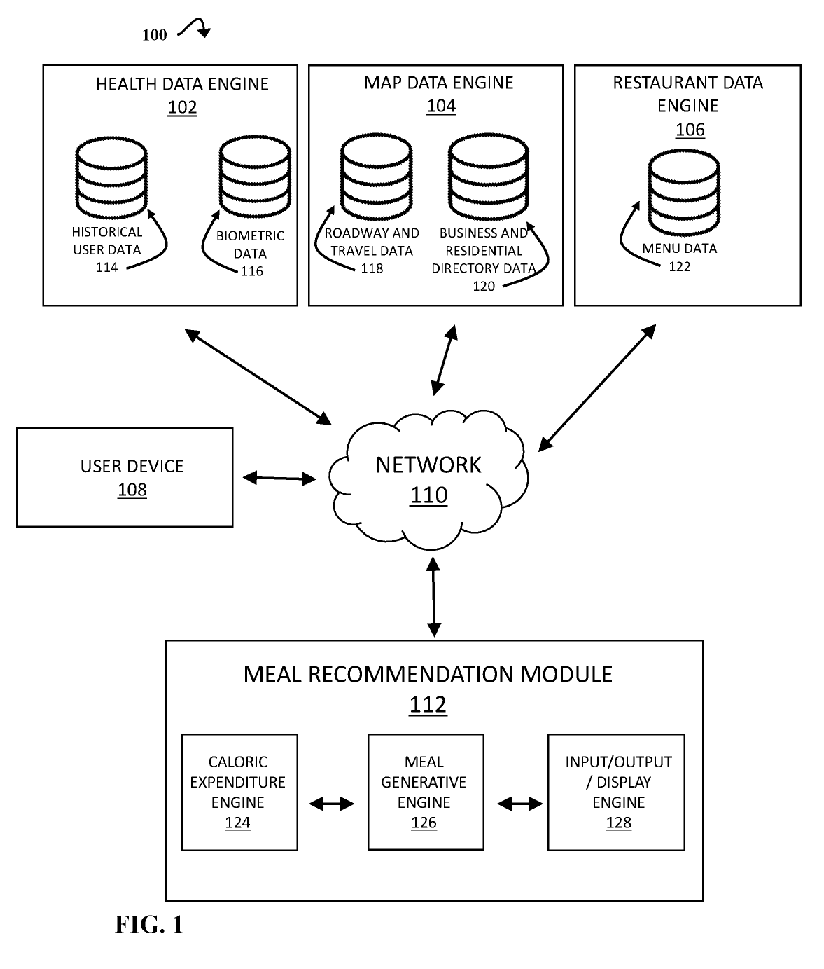

FIG. 1 depicts a system diagram 100 for recommending a meal to a user, according to embodiments. In embodiments, system 100 of FIG. 1 is carried out on various computer processing circuits, and may include more, fewer, or different engines than those described herein. Embodiments of the system may comprise more, fewer, or the same engines described here, and may include a health data engine 102, a map data engine 104, a restaurant data engine 106, and a meal recommendation module 112, which may be comprised of three engines including a caloric expenditure engine 124, a meal generative engine 126, and an input/output and display engine 128. The system may also comprise a user device or devices as depicted at user device 108. Each of these engines, modules, and devices may be physically or communicatively coupled, and may communicate over one or more networks 110. The network 110 can include, but is not limited to, local area networks, point-to-point communications, wide area networks, the global Internet, other appropriate networks, and combinations thereof.

According to embodiments, a caloric expenditure engine 124 of a meal recommendation module 112 may communicate, across the network 110 with the health data engine 102 to identify a calorie remainder for a particular user for a predetermined period of time. For example, a calorie remainder for a user for a day may be identified. In other embodiments, a predetermined period of time could be a month, a week, an hour, or another time period, according to user settings and preferences, as well as a user's goals. The health data engine 102 may comprise a set of historical user data 114 and biometric data 116. In embodiments, these databases may contain user-specific data and may be encrypted or otherwise protected, as is appropriate to various regulations and laws.

In embodiments, the historical user data could comprise a set of data regarding the user's past activity levels, average caloric expenditures, doctor or other expert provided calorie goals, fitness data, or other data. Historical user data 114 may also include food or nutrition data, as reported by a user or other application. For example, a set of foods consumed by the user for that day, week, or other time period may be contained within the historical user data 114. In embodiments, this data may be located on and accessed from the user device. In embodiments, the data may be input manually (e.g., by the user or by a professional), or collected automatically (e.g., from a fitness or other health application or device, from a set of healthcare data). In embodiments, the biometric data 116 may comprise a set of biometric data about a user or set of users including body weight, height, age, gender, and other relevant data. A health data engine 102 may generate the caloric remainder, based on the historical user data 114 for the user and the biometric data 116.

The map data engine 104 can generate a set of restaurant recommendations. The map data engine 104 may comprise a roadway and travel data database 118 and a database for business and residential directory data 120. In embodiments, the roadway and travel data may comprise a set of data collected from a global positioning service (GPS) application or a travel application, for example, a mapping application on a user device, and may contain data about various travel paths (e.g., roadways, bike trails, sidewalks, etc.). The roadway and travel data 118 may also include traffic data or other relevant data useful in predicting travel paths and times. The map data engine may also be coupled with a database for storing business and residential directory data 120. This data may comprise a list of businesses, restaurants, residences and other locations, as well as their addresses and locations on a map. In embodiments, the map data engine 104 may generate a set of restaurant recommendations using a user-provided location, or based on a location accessed from the user device 108.

A restaurant data engine 106 may comprise a database of menu data 122 for a set of restaurants. The restaurant data engine 106 may generate a set of menu combinations from a set of menus at each restaurant, and correlate those combinations (e.g., a set of meals) with associated calories for each meal at each restaurant in a set of restaurants. For example, the restaurant data engine 106 may generate for a particular restaurant, a variety of menu combinations that each meet a particular number of calories. Similarly, the restaurant data engine 106 may also generate a variety of menu combinations for a range of calories. In embodiments, the generation of the meals and associated calories may be handled by another engine (e.g., the meal generative engine 126 of the meal recommendation module 112), or generated with a combination of engines (e.g., the restaurant data engine 106 could pull the calorie and menu data from the database containing menu data 122 and the meal generative engine 126 could sort the menu items into calorie-specific combinations).

In embodiments, the caloric expenditure engine 124 could then determine a caloric expenditure for a user's travel to each restaurant. This determination can be made using health data (e.g., the health data discussed herein in regards to the health data engine 102) as well as the map data (e.g., the map data discussed herein in regards to the map data engine 104). In embodiments, this may involve applying the data to a natural language processing system to generate a set of caloric expenditures for travel, by the user, to each destination, according to a variety of means of transportation. For example, the caloric expenditure engine 124 could determine a number of calories a user may expend if the user biked from his current location to a particular restaurant. This determination could be made using health data (e.g., historical information regarding average caloric expenditure of past biking trips) as well as map data (e.g., a set of bike-safe paths to the particular restaurant). Similar determinations could be made for a variety of restaurants in the geographic area and using different means of transportation (e.g., walking, jogging, running, public transit, driving, or other travel options). In embodiments, a caloric expenditure could be determined for user travel in the future, or beginning from another location. For example, a user may be at the office, but want to plan his lunchtime travel from an off-site morning meeting, and thus may provide the meal recommendation module 112, through the user device 108, an address or location name of the off-site meeting, in order to determine caloric expenditures for a trip later in the day.

In embodiments, the meal generative engine 126 may then generate a set of meal recommendations. In embodiments, the meal generative engine 126 may use the identified remaining caloric expenditure for the set time period (e.g., day), which may be identified, as described herein, from the health data engine 102. The meal generative engine 126 may also access the set of caloric expenditures for the travel (e.g., as determined by the caloric expenditure engine 124) as well as the set of meal recommendations (e.g., the identified recommendations from the restaurant data engine 106), in order to generate a set of meal recommendations suitable to the user, at a variety of locations.

In embodiments, the meal generative engine 126 may then send the data to the input/output (I/O) and display engine 128 of the meal recommendation module 112. The I/O and display engine 128 may provide the data to the user device 108, in a variety of formats and based on user-established configurations. For example, the I/O and display engine 128 may provide the meal recommendations in a list form of restaurants (e.g., a list of all restaurants at which meals have been recommended), in a list form of distances to travel (e.g., a list of distances from the user-determined location the restaurants are located), in a list form of physical activities required (e.g., a list of various activities including biking, walking and other activities, as well as distances, a user could participate in to reach the restaurant), or in another manner. Each of these initial data presentations could include selectable options on the user interface to lead to the meal recommendations generated by the meal generative engine 126 of the meal recommendation module 112.

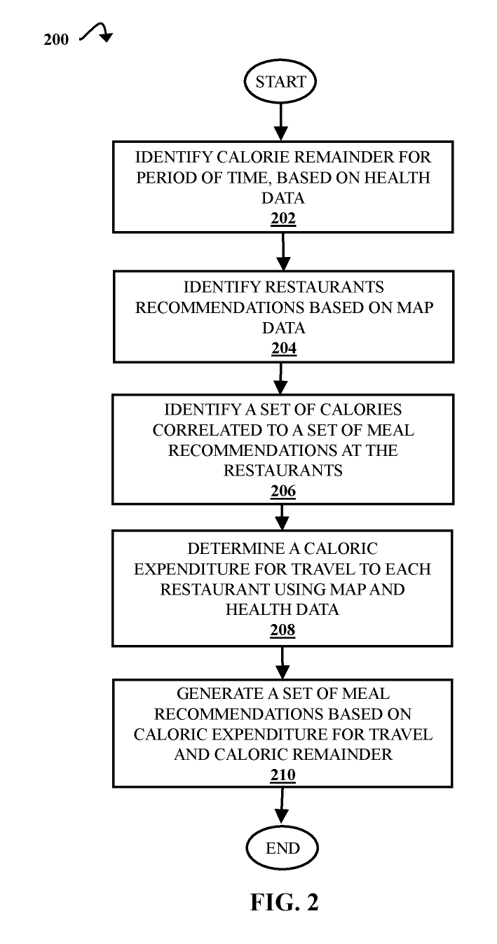

FIG. 2 depicts a flow chart of a method 200 for generating a set of meal recommendations, according to embodiments. The method 200 may be carried out over a set of processing circuits, as described herein. The method may start by identifying a calorie remainder for a period of time based on health data, per 202. The period of time may be a predetermined period of time, such as a day. In embodiments, as described herein, the health data may be user-provided, healthcare provider provided, accessed from peer-reviewed articles, collected from user devices, or identified in another way. For example, a calorie remainder of 850 calories could be identified for the user for the remainder of the day, based on a user-provided target of a 2,000 calories per day intake. A set of restaurant recommendations could be identified based on map data, per 204. In embodiments, the recommendations could be identified based on geographic proximity, historical user data (e.g., places the user has frequently visited), or in another way. For example, a restaurant the user often visits that is 2.5 miles away according to the map data could be included in the set of restaurant recommendations.

Per 206, a set of calories correlated to a set of meal recommendations at the restaurants could then be identified. In embodiments, this could comprise identifying a set of menu items and their associated calorie content, then generating a set of meal recommendations (i.e., combinations of various menu items) and their associated combined calorie content.

At 208, the system, for example, the meal recommendation module 112 of system 100 of FIG. 1, could then determine a caloric expenditure for travel to each restaurant in the recommended restaurants using map and health data. As described herein, historical fitness data could be used to identify a caloric expenditure for each type of travel (e.g., walking at a particular speed or speeds, jogging, biking, or other forms of fitness). The health data used could also be used to calculate the expenditure of a non-fitness related travel (e.g., factoring in average walking, sitting, and standing times and caloric expenditure, respectively, when taking public transit). The system could use map data to identify a set of paths (e.g., bike-safe paths, walking-safe paths, public transit routes, vehicle roadways, or other paths) suitable for travel by the user. The system could use this data to generate a set of travel options to each restaurant and the calories associated with each. In embodiments, and according to user settings, the system could determine the caloric expenditure for a single trip (e.g., calories burned walking to the restaurant), or it could determine the caloric expenditure for a round trip (e.g., calories burned walking to and from the restaurant).

Using this data, as well as the caloric remainder data, the system could generate a set of meal recommendations to a user, per 210. The meal recommendations could be associated with each restaurant from which they may be ordered. The meal recommendations, as defined herein, may comprise a meal (e.g., an item or items from a menu) and travel combination that result in an overall caloric intake that falls at or below the caloric remainder for the time period (e.g., day). The meal recommendation may also include a name of the restaurant at which the meal may be obtained. The system may then end, or may transmit the recommendation data for display. For example, the recommendation data may be transmitted to a user device such as a smart phone, tablet, personal fitness device, personal computer, or other display device.

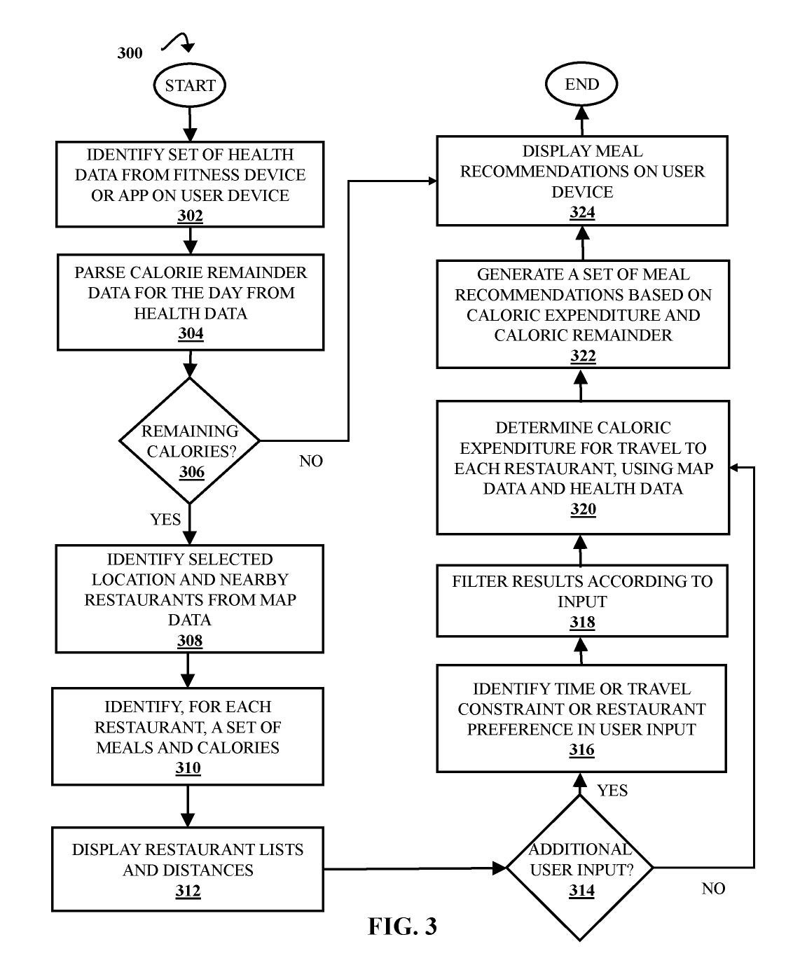

FIG. 3 depicts a flow diagram of a method 300 for recommending and displaying a set of meal recommendations within a particular calorie restriction, according to embodiments. FIG. 3 may be executed via a set of computer processor circuits and may be embodied in a system of engines and executed by a meal recommending modules as illustrated at FIG. 1. The method 300 may start when the system identifies a set of health data from a fitness device or application on a user device, per 302. The system may parse calorie remainder data for the day from a set of health data, per 304. The system may then determine if any calories remain for the user for the day, per 306. If no, the system may display a meal recommendation on the user device, per 324, that recommends that there are no suitable meals for the user and his caloric targets for the day. If the system determines, at block 306, there are remaining calories for the day, a location may be identified and with it, a set of nearby restaurants, per 308. As described herein, the set of restaurants may be selected from a set of map data including geographic and traffic data as well as business location data.

In embodiments, the system may also identify a set of meal and the calories associated with each meal, per 310. As used herein, a “meal” may be defined as a set of one or more menu options available to a user.

In some embodiments, the system may communicate this data to a user device and display the restaurant list to the user as well as the distances associated with each restaurant (e.g., the approximate travel distances to each location based on the user's specified origin location), per 312. In embodiments, the system may monitor for additional user input, per 314. If no additional input is received, the system may determine a caloric expenditure for travel to each of the identified restaurants using health and map data, per 320 and as described herein. The system may then generate a set of meal recommendations that are suitable for the user based on the identified caloric remainder and determined caloric expenditure for each of the restaurants, per 322. Finally, the meal recommendation may be displayed on the user device, per 324.

However, if at 314, the system detects additional user input, for example, a selection of a travel constraint or restaurant preference, the system may identify this input, per 316. For example, a time constraint may be provided, a travel constraint, or a restaurant preference may be provided, per 316. The system may then filter the results according to the input, per 318. For example, a set of restaurants too far away from the origin location may be removed from the set, and thus their associated meals (e.g., menu items) would not be included in the set. For example, a particular restaurant or genre of food may be selected (e.g., the user may select a particular restaurant by name or select a “type” of food, for example, fast food, at 314). Any restaurants falling outside of the selection would be filtered, per 318. Using this new, edited data set, the caloric expenditure for each of the remaining restaurants may be calculated, per 320, and a set of meal recommendations based on caloric expenditure and remaining calories for the day may be generated, per 322, and displayed, per 324. The system may then end.

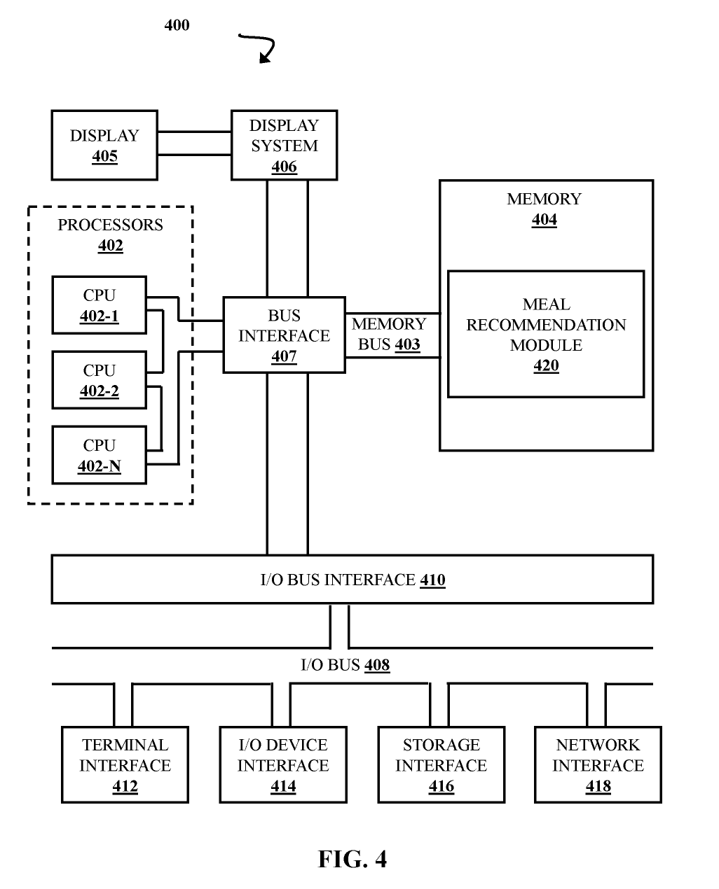

FIG. 4 is a high-level block diagram illustrating an exemplary computer system 400 that can be used in implementing one or more of the methods, tools, components, and any related functions described herein (e.g., using one or more processor circuits or computer processors of the computer). In some embodiments, the major components of the computer system 400 comprise one or more processors 402, a memory subsystem 404, a terminal interface 412, a storage interface 416, an input/output device interface 414, and a network interface 418, all of which can be communicatively coupled, directly or indirectly, for inter-component communication via a memory bus 403, an input/output bus 408, bus interface unit 407, and an input/output bus interface unit 410.

The computer system 400 contains one or more general-purpose programmable central processing units (CPUs) 402-1, 402-2, and 402-N, herein collectively referred to as the CPU 402. In some embodiments, the computer system 400 contains multiple processors typical of a relatively large system; however, in other embodiments the computer system 400 can alternatively be a single CPU system. Each CPU 402 may execute instructions stored in the memory subsystem 410 and can include one or more levels of on-board cache.

The memory 404 can include a random-access semiconductor memory, storage device, or storage medium (either volatile or non-volatile) for storing or encoding data and programs. In some embodiments, the memory 404 represents the entire virtual memory of the computer system 400, and may also include the virtual memory of other computer systems coupled to the computer system 400 or connected via a network. The memory 404 is conceptually a single monolithic entity, but in other embodiments the memory 404 is a more complex arrangement, such as a hierarchy of caches and other memory devices. For example, memory may exist in multiple levels of caches, and these caches may be further divided by function, so that one cache holds instructions while another holds non-instruction data, which is used by the processor or processors. Memory can be further distributed and associated with different CPUs or sets of CPUs, as is known in any of various so-called non-uniform memory access (NUMA) computer architectures.

These components are illustrated as being included within the memory 404 in the computer system 400. However, in other embodiments, some or all of these components may be on different computer systems and may be accessed remotely, e.g., via a network. The computer system 400 may use virtual addressing mechanisms that allow the programs of the computer system 400 to behave as if they only have access to a large, single storage entity instead of access to multiple, smaller storage entities. Further, although these components are illustrated as being separate entities, in other embodiments some of these components, portions of some of these components, or all of these components may be packaged together.

In an embodiment, the trigger generation module 420 includes instructions that execute on the processor 402 or instructions that are interpreted by instructions that execute on the processor 402 to carry out the functions as further described in this disclosure. In another embodiment, the meal recommendation module 420 is implemented in hardware via semiconductor devices, chips, logical gates, circuits, circuit cards, and/or other physical hardware devices in lieu of, or in addition to, a processor-based system. In another embodiment, the meal recommendation module 420 includes data in addition to instructions. In embodiments, meal recommendation module 420 may be the meal recommendation module 112 of FIG. 1.

Although the memory bus 403 is shown in FIG. 4 as a single bus structure providing a direct communication path among the CPUs 402, the memory subsystem 410, the display system 406, the bus interface 407, and the input/output bus interface 410, the memory bus 403 can, in some embodiments, include multiple different buses or communication paths, which may be arranged in any of various forms, such as point-to-point links in hierarchical, star or web configurations, multiple hierarchical buses, parallel and redundant paths, or any other appropriate type of configuration. Furthermore, while the input/output bus interface 410 and the input/output bus 408 are shown as single respective units, the computer system 400 may, in some embodiments, contain multiple input/output bus interface units 410, multiple input/output buses 408, or both. Further, while multiple input/output interface units are shown, which separate the input/output bus 408 from various communications paths running to the various input/output devices, in other embodiments some or all of the input/output devices may be connected directly to one or more system input/output buses.

The computer system 400 may include a bus interface unit 407 to handle communications among the processor 402, the memory 404, a display system 406, and the input/output bus interface unit 410. The input/output bus interface unit 410 may be coupled with the input/output bus 408 for transferring data to and from the various input/output units. The input/output bus interface unit 410 communicates with multiple input/output interface units 412, 414, 416, and 418, which are also known as input/output processors (IOPs) or input/output adapters (IOAs), through the input/output bus 408. The display system 406 may include a display controller. The display controller may provide visual, audio, or both types of data to a display device 405. The display system 406 may be coupled with a display device 405, such as a standalone display screen, computer monitor, television, or a tablet or handheld device display. In alternate embodiments, one or more of the functions provided by the display system 406 may be on board a processor 402 integrated circuit. In addition, one or more of the functions provided by the bus interface unit 407 may be on board a processor 402 integrated circuit.

In some embodiments, the computer system 400 is a multi-user mainframe computer system, a single-user system, or a server computer or similar device that has little or no direct user interface, but receives requests from other computer systems (clients). Further, in some embodiments, the computer system 400 is implemented as a desktop computer, portable computer, laptop or notebook computer, tablet computer, pocket computer, telephone, smart phone, network switches or routers, or any other appropriate type of electronic device.

It is noted that FIG. 4 is intended to depict the representative major components of an exemplary computer system 400. In some embodiments, however, individual components may have greater or lesser complexity than as represented in FIG. 4, Components other than or in addition to those shown in FIG. 4 may be present, and the number, type, and configuration of such components may vary.

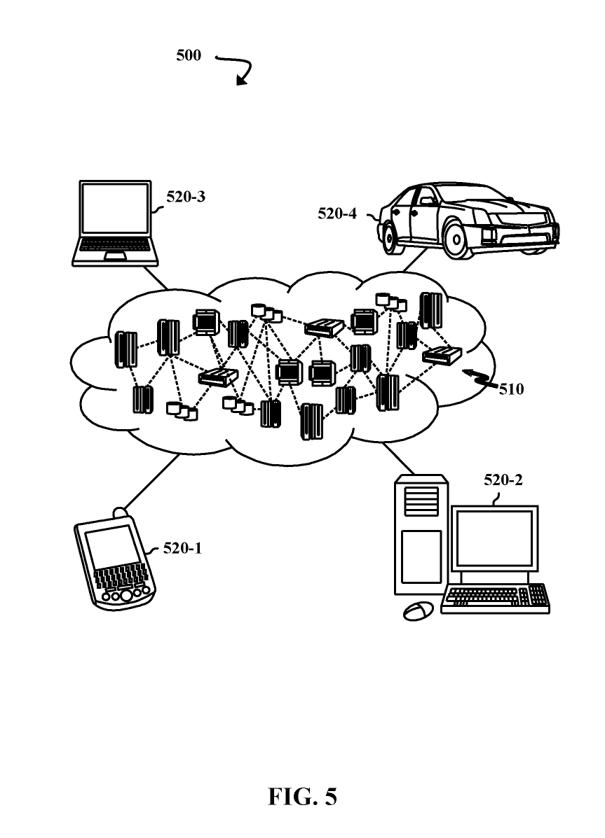

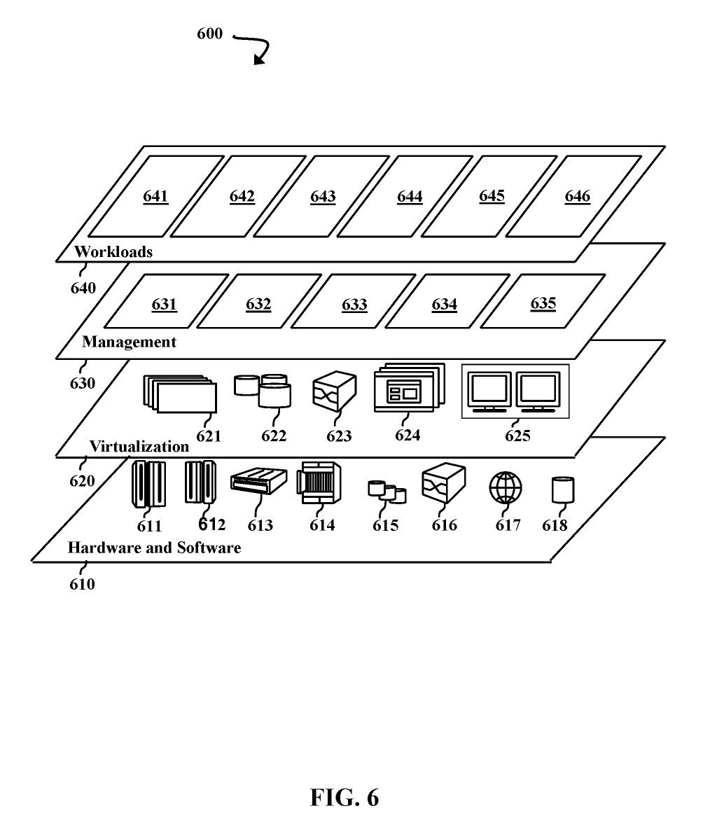

In some embodiments, the data storage and retrieval processes described herein could be implemented in a cloud computing environment, which is described below with respect to FIGS. 5 and 6. It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

Referring now to FIG. 5, illustrative cloud computing environment 500 is depicted. As shown, cloud computing environment 600 includes one or more cloud computing nodes 510 with which local computing devices used by cloud consumers, such as, for example, personal digital assistant (PDA) or cellular telephone 520-1, desktop computer 520-2, laptop computer 520-3, and/or automobile computer system 520-4 may communicate. Nodes 510 may communicate with one another. They may be grouped (not shown) physically or virtually, in one or more networks, such as Private, Community, Public, or Hybrid clouds as described hereinabove, or a combination thereof. This allows cloud computing environment 500 to offer infrastructure, platforms and/or software as services for which a cloud consumer does not need to maintain resources on a local computing device. It is understood that the types of computing devices 520-1-520-4 shown in FIG. 5 are intended to be illustrative only and that computing nodes 510 and cloud computing environment 500 can communicate with any type of computerized device over any type of network and/or network addressable connection (e.g., using a web browser).

Referring now to FIG. 6, a set of functional abstraction layers 600 provided by cloud computing environment 500 (FIG. 5) is shown. It should be understood in advance that the components, layers, and functions shown in FIG. 6 are intended to be illustrative only and embodiments of the invention are not limited thereto. As depicted, the following layers and corresponding functions are provided:

Hardware and software layer 610 includes hardware and software components. Examples of hardware components include: mainframes 611; RISC (Reduced Instruction Set Computer) architecture based servers 612; servers 613; blade servers 614; storage devices 615; and networks and networking components 616. In some embodiments, software components include network application server software 617 and database software 618.

Virtualization layer 620 provides an abstraction layer from which the following examples of virtual entities may be provided: virtual servers 621; virtual storage 622; virtual networks 623, including virtual private networks; virtual applications and operating systems 624; and virtual clients 625.

In one example, management layer 630 provides the functions described below. Resource provisioning 631 provides dynamic procurement of computing resources and other resources that are utilized to perform tasks within the cloud computing environment. Metering and Pricing 632 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 633 provides access to the cloud computing environment for consumers and system administrators. Service level management 634 provides cloud computing resource allocation and management such that required service levels are met. Service Level Agreement (SLA) planning and fulfillment 635 provide pre-arrangement for, and procurement of, cloud computing resources for which a future requirement is anticipated in accordance with an SLA.

Workloads layer 640 provides examples of functionality for which the cloud computing environment can be utilized. Examples of workloads and functions that can be provided from this layer include: mapping and navigation 641; software development and lifecycle management 642; virtual classroom education delivery 643; data analytics processing 644; transaction processing 645; and machine learning for reaction rule database correction 646.

The present disclosure may be a system, a method, and/or a computer program product. The computer program product may include a computer readable storage medium (or media) having computer readable program instructions thereon for causing a processor to carry out aspects of the present disclosure.

The computer readable storage medium is a tangible device that can retain and store instructions for use by an instruction execution device. Examples of computer readable storage media can include an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network can comprise copper transmission cables, optical transmission fibers, wireless transmission, routers, firewalls, switches, gateway computers, and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a component, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

What is claimed is:

1. A method comprising:
identifying, based on a set of health data, a calorie remainder for a predetermined period of time;
identifying, based on a set of map data, a set of restaurant recommendations;
identifying, based on a set of restaurant data, a set of calories correlated to a set of meals at each of the restaurants;
determining, using the map data and the health data, a caloric expenditure for travel to each restaurant; and
generating, based on the caloric expenditure for travel, the set of meals and the correlated set of calories, and the caloric remainder for the predetermined period of time, a set of meal recommendations.

2. The method of claim 1, further comprising displaying the recommendations via a user interface.

3. The method of claim 1, wherein the caloric expenditure comprises a set of caloric expenditures for a variety of travel options.

4. The method of claim 3, wherein the travel options include biking.

5. The method of claim 3, wherein the travel options include walking at a particular average speed.

6. The method of claim 1, wherein the travel comprises a single trip.

7. The method of claim 1, wherein the travel comprises a return trip.

8. A system comprising:
a caloric expenditure engine configured to:
identify, based on a set of health data, a calorie remainder for a predetermined period of time;
identify, based on a set of map data, a set of restaurant recommendations; and
a meal generative engine configured to:
identify, based on a set of restaurant data, a set of calories correlated to a set of meals at each of the restaurants;
determine, using the map data and the health data, a caloric expenditure for travel to each restaurant; and
generate, based on the caloric expenditure for travel, the set of meals and the correlated set of calories, and the caloric remainder for the predetermined period of time, a set of meal recommendations.

9. The system of claim 8, further comprising an input/output and display engine configured to display the recommendations via a user interface.

10. The system of claim 8, wherein the caloric expenditure comprises a set of caloric expenditures for a variety of travel options.

11. The system of claim 10, wherein the travel options include biking.

12. The system of claim 10, wherein the travel options include walking at a particular average speed.

13. The system of claim 8, wherein the travel comprises a single trip.

14. The system of claim 8, wherein the travel comprises a return trip.

15. A computer program product comprising a computer readable storage medium having program instructions embodied therewith, wherein the computer readable storage medium is not a transitory signal per se, the program instructions executable by a processor to cause the processor to perform a method comprising:
identifying, based on a set of health data, a calorie remainder for a predetermined period of time;
identifying, based on a set of map data, a set of restaurant recommendations;
identifying, based on a set of restaurant data, a set of calories correlated to a set of meals at each of the restaurants;
determining, using the map data and the health data, a caloric expenditure for travel to each restaurant; and
generating, based on the caloric expenditure for travel, the set of meals and the correlated set of calories, and the caloric remainder for the predetermined period of time, a set of meal recommendations.

16. The computer program product of claim 15, wherein the method further comprises displaying the recommendations via a user interface.

17. The computer program product of claim 15, wherein the caloric expenditure comprises a set of caloric expenditures for a variety of travel options.

18. The computer program product of claim 17, wherein the travel options include biking.

19. The computer program product of claim 15, wherein the travel comprises a single trip.

20. The computer program product of claim 15, wherein the travel comprises a return trip.
